(19) United States
(12) Patent Application Publication
(10) Pub. No.: US 2011/0088502 A1
(43) Pub. Date: Apr. 21, 2011

(54) STEERING COLUMN WITH INTEGRATED SHAFT BEARING AND TUBE-MOUNTED SLIDABLE YOKE

(75) Inventors: Christopher Brown, Plymouth, MI (US); Shakeel Shaikh, Windsor (CA)

(73) Assignee: SCHAEFFLER TECHNOLOGIES GMBH & CO. KG, Herzogenaurach (DE)

(21) Appl. No.: 12/907,440

(22) Filed: Oct. 19, 2010

Related U.S. Application Data
(60) Provisional application No. 61/252,742, filed on Oct. 19, 2009.

(51) Int. Cl. B62D 1/185

(52) U.S. Cl. 74/493

(57) ABSTRACT

A vehicle steering column assembly for transmitting steering movement from a steering wheel of a vehicle steering system. The assembly includes an integrated shaft bearing that connects to the steering wheel at one end, a tube assembly interconnected with the integrated shaft bearing at its other end, a yoke assembly having a shaft and being adapted to be interconnected with a lower steering component of the steering system, and a bearing assembly disposed within the tube assembly and around the shaft to support the shaft in axial sliding movement within the tube assembly.

### CROSS-REFERENCE TO RELATED APPLICATION

This application claims the priority of U.S. Provisional Application No. 61/252,742, filed Oct. 19, 2009, the complete disclosure of which is hereby incorporated by reference.

### TECHNICAL FIELD

The invention relates to steering systems for vehicles, and more specifically to the upper steering column of the steering system.

### BACKGROUND OF THE INVENTION

Vehicle steering columns involve a combination of shafts and bearing assemblies. In many cases, the combination leaves many parts to be assembled during the final manufacturing or integration of the steering system, a process that may be complicated, time-consuming, and expensive. For example, to install the steering columns and their shafts that transfer steering movement to the lower steering system components, some steering column designs require assembly of the bearings onto the shafts as a part of the final vehicle assembly. This may require handling and interconnection of a number of parts by either the steering column manufacturer or the vehicle manufacturer itself.

As is known, it is desirable in vehicle steering systems to permit at least some axial adjustment of the steering system components, whether for purposes of permitting telescopic adjustments of the steering wheel by the end vehicle user or for purposes of accounting for manufacturing tolerances during installation. Slidable linear guides, such as shown in U.S. Pat. No. 6,948,401, have been used in lower steering components, for example, below the I-shaft of a typical steering system.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a perspective view showing a steering column constructed in accordance with an embodiment of the invention, and showing the steering column in its intended environment within a vehicle steering system;

FIG. 2 is a perspective view of the steering column of FIG. 1;

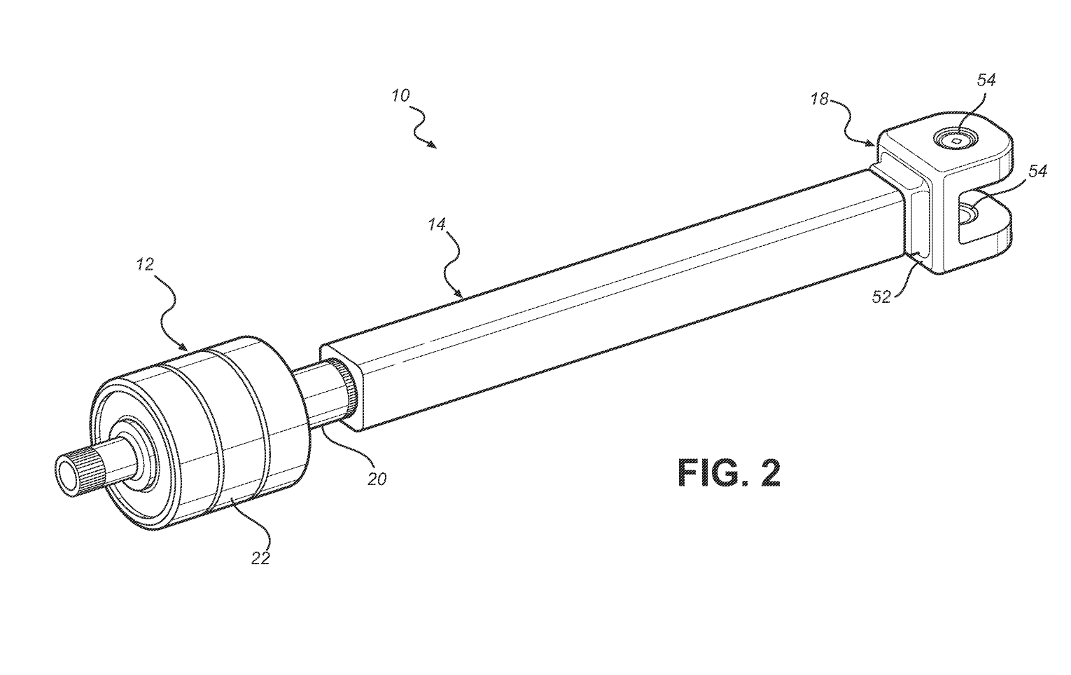

FIG. 3 is an exploded perspective view of the steering column of FIG. 1 showing the major component parts; and

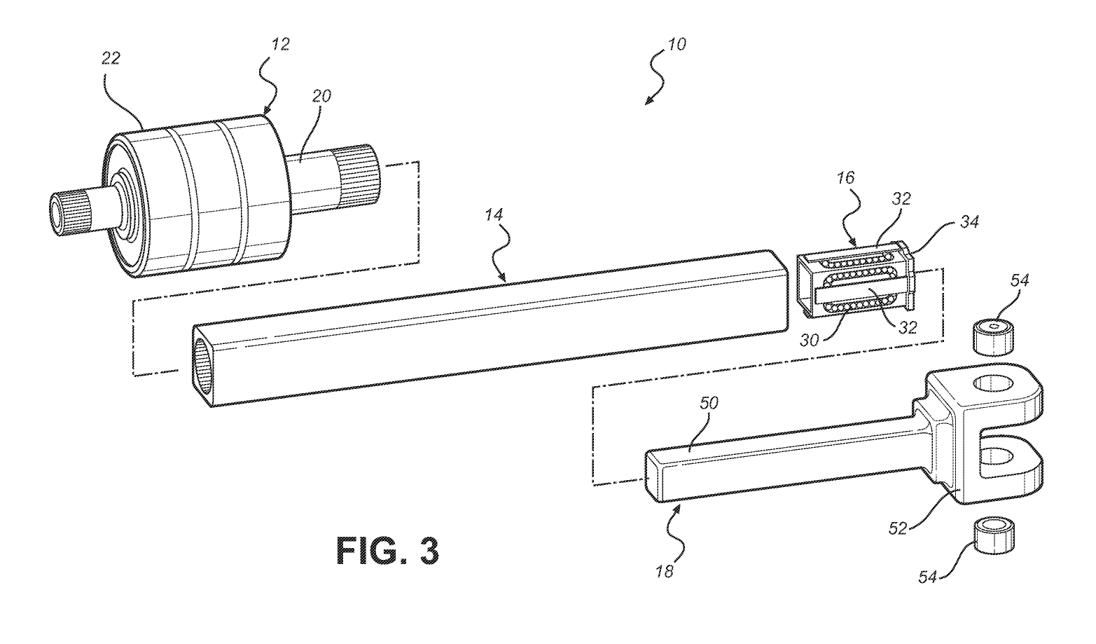

FIG. 4 is an exploded view of the steering column of FIG. 1 showing sections of the major component parts.

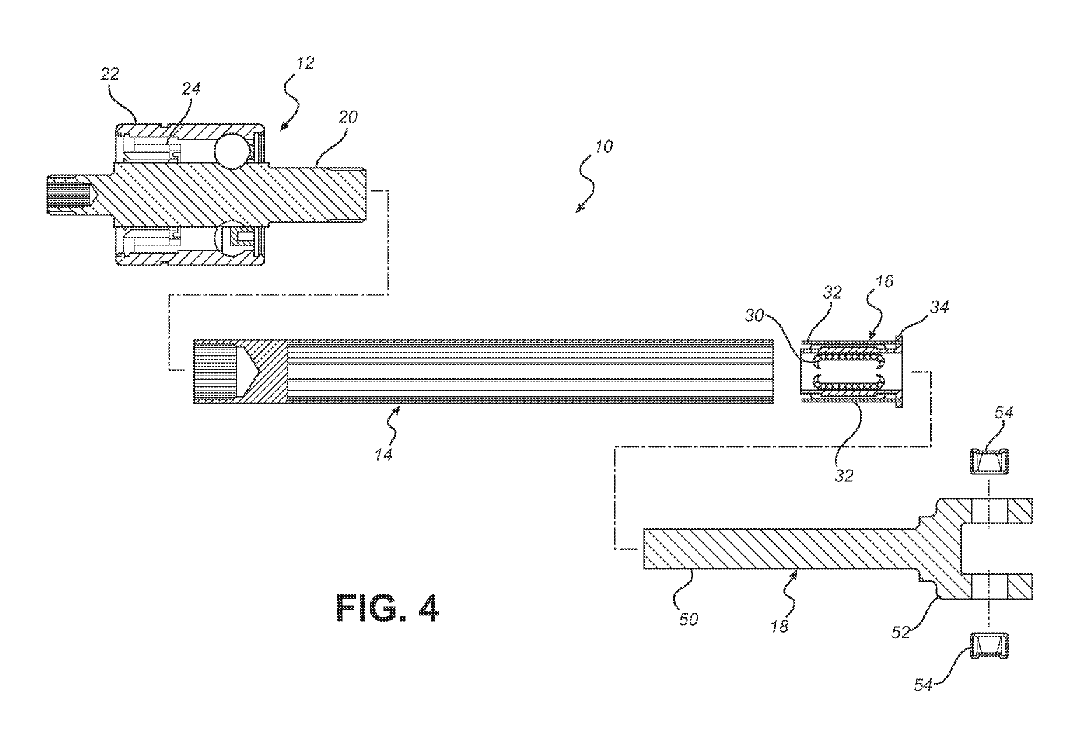

### SUMMARY OF THE INVENTION

In accordance with one embodiment of the invention, there is provided a vehicle steering column assembly for transmitting steering movement from a steering wheel of a vehicle steering system. The assembly includes the following: an integrated shaft bearing adapted to be interconnected with the steering wheel; a tube assembly interconnected with the integrated shaft bearing; a yoke assembly adapted to be interconnected with lower steering component of the steering system, where the yoke assembly includes a shaft that telescopes within the tube assembly; and a bearing assembly disposed within the tube assembly and around the shaft to support the shaft in axial sliding movement within the tube assembly.

### DETAILED DESCRIPTION OF THE PREFERRED EMBODIMENTS

The illustrated embodiment described below provides a simplified steering column in that, when compared to some steering column designs in use today, it reduces the number of parts that must be handled and interconnected during assembly of the steering column. With its few parts being already pre-assembled into a unit, all that remains during final assembly is for the manufacturer to press-fit the unit into the steering column jacket, and connect it to the steering wheel at one end and to the I-shaft on the other end. Although an exemplary embodiment is described below in conjunction with the accompanying drawings, it will be appreciated by those skilled in the art that various alternative designs can be implemented such as, for example, different mounting approaches for interconnecting the assembly to a steering column jacket, different types of rigid or pivotal interconnections to the steering wheel, and different types of rotational-pivotal connections of the assembly at its lower end to the remainder of the steering system. Some of these other modifications are noted in the description below.

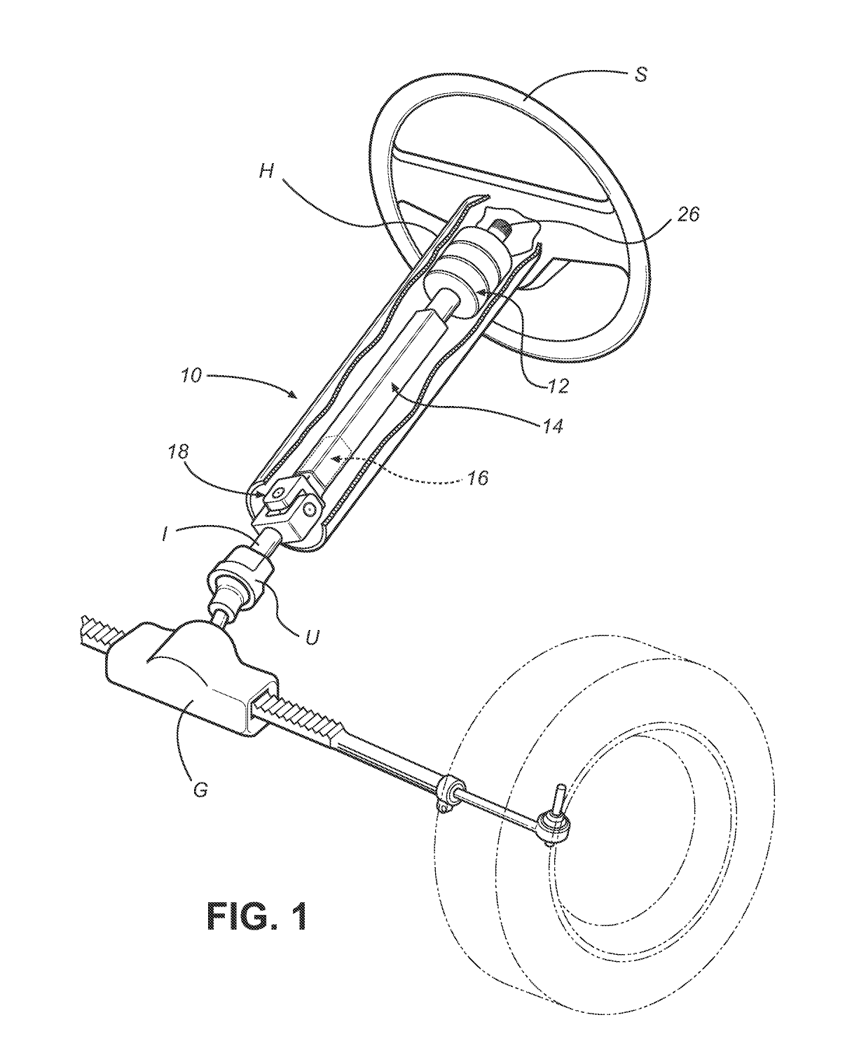

FIG. 1 shows an embodiment of the invention in the form of a steering column assembly, generally indicated at 10, in its intended environment, which is a steering system for a vehicle. In the illustrated embodiment, the steering column assembly 10 is disposed between the steering wheel S and an I-shaft, which comprises a part of the lower portion of the vehicle steering system and is denoted I in FIG. 1. Any suitable lower steering and tie rod assemblies can be used, in this case, the lower portion of the steering system includes the I-shaft I which is connected via a universal joint U to a steering gear G which transfers the steered rotation of the I-shaft to a rack and thus, to the steered vehicle wheels. The assembly 10 includes an integrated shaft bearing generally indicated at 12, a tube assembly generally indicated at 14, a bearing assembly generally indicated at 16 and a yoke assembly generally indicated at 18. As shown in FIG. 1, the assembly 10 can be packaged in a steering column jacket or housing H.

The integrated shaft bearing 12 generally includes a shaft 20, a sleeve 22, and a bearing assembly 24 disposed between the shaft and the sleeve. In the past, integrated shaft bearings have been adapted for use in connection with other devices such as water pumps. An example of an integrated shaft bearing is shown in United States Patent Application Publication No. 2008/0131038 A1. This publication shows a few examples of how bearing assemblies can be disposed between a shaft and a sleeve. Other integrated shaft bearing designs are known or will be apparent to those skilled in the art. For example, the applicant's web site (www.schaeffler.com) showed other possible bearing assemblies that were available as of the filing date of this application.

The shaft 20 is adapted to be interconnected to the steering wheel, either directly or via one or more other components. This can be done in any suitable manner; for example, in the illustrated embodiment, shaft 20 includes splining, knurling or the like on one end 26 of the shaft for connection to the hub of a steering wheel S, and this splining or other suitable structure can be used on the other end of the shaft 20 for connection to the tube assembly 14. As another example, in addition to or in lieu of a spline, locking rings or pins can be used to interconnect the steering wheel S and the shaft 20.

The integrated shaft bearing 12 connects to tube assembly 14, as mentioned. The tube assembly 14 can include a tube that is generally square in cross-section, as shown in the figures. Other cross-sectional shapes can be used that, together with the bearing assembly 18, permit rotational movement of the tube assembly 14 to the yoke assembly 18. The tube assembly can include splining of the type shown in the figures for mating with the splining on the integrated shaft bearing 12. Again, other types of interconnections of shaft 20 with tube assembly 14 can be used and will be apparent to those skilled in the art.

The tube assembly 14 supports a bearing assembly 16. The bearing assembly 16 can be a linear slider-type bearing or other bearing suitable to support the yoke assembly 18 as the yoke assembly slides in a telescoping manner within the tube assembly 14. The bearing assembly 16 may include balls or rollers 30 as shown. The bearing assembly 16 may also include tabs 32 for supporting the bearing assembly, and an end flange 34 for limiting the extent to which the bearing assembly may be inserted into the tube assembly 14. Thus, in one embodiment, the bearing assembly 16 an be fixedly attached to the tube assembly 14 so that there is no relative motion therebetween, with the yoke assembly 18 can telescopically slide through the bearing 16 and tube assembly 14.

The yoke assembly 18 includes an elongated shaft 50 that telescopes within the tube assembly 14. The shaft 50 has a generally square cross section for mating with the cross section in the tube assembly 14 and bearing assembly 16. The square cross section allows for the transmission of rotational movement between the tube assembly 14 and the yoke assembly 18. At the same time, the shaft 50 can move axially within the tube assembly 14 a predetermined amount, and the bearing assembly 16 supports the shaft 50 in that axial (telescoping) movement.

The yoke assembly also includes a U-joint 52 that is adapted to connect with the I-shaft I. The U-joint includes bores or cavities which facilitate the insertion of bearings 54. The bearings 54 can be ball style needle bearings or other suitable means for facilitating motion transfer between the assembly 10 and the I-shaft. Other suitable implementations of the U-joint 52 that may or may not include bearings will be known to those skilled in the art.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A vehicle steering column assembly for transmitting steering movement from a steering wheel of a vehicle steering system, the assembly comprising:
an integrated shaft bearing adapted to be interconnected with a steering wheel;
a tube assembly interconnected with the integrated shaft bearing;
a yoke assembly adapted to be interconnected with a lower steering component of a steering system, the yoke assembly including a shaft that telescopes within the tube assembly; and
a bearing assembly disposed within the tube assembly and around the shaft to support the shaft in axial sliding movement within the tube assembly.

2. A vehicle steering column assembly as defined in claim 1, wherein the bearing assembly is fixedly attached to the tube assembly such that the shaft of the yoke assembly slides within the bearing assembly.

3. A vehicle steering column assembly as defined in claim 1, wherein the integrated shaft bearing includes a shaft having a spline at at least one end, and wherein the tube assembly includes a mating spline, with the tube assembly and shaft of the integrated shaft bearing are interconnected via the splines.

4. A vehicle steering column assembly as defined in claim 3, wherein the shaft of the integrated shaft bearing includes a spline at its other end, and wherein the other end is attaches directly to a hub of the steering wheel.

5. A vehicle steering column assembly as defined in claim 1, wherein the integrated shaft bearing is adapted to be press-fit within a steering column jacket of the vehicle steering system.

6. A vehicle steering column assembly as defined in claim 1, wherein the yoke assembly includes a universal joint attached to the shaft.

7. A vehicle steering column assembly as defined in claim 6, wherein the universal joint includes bearings for interconnecting the universal joint to another universal joint of a lower steering system component.
